(19) United States
(12) Patent Application Publication
(10) Pub. No.: US 2021/0304195 A1
(43) Pub. Date: Sep. 30, 2021

(54) METHOD FOR BLOCKCHAIN PAYMENT CHANNEL NETWORK MULTI-PATH ROUTING BASED ON GENETIC ALGORITHM

(71) Applicant: WUHAN UNIVERSITY, Wuhan (CN)

(72) Inventors: Yanjiao CHEN, Wuhan (CN); Xiaotian ZHU, Wuhan (CN)

(73) Assignee: WUHAN UNIVERSITY, Wuhan (CN)

(21) Appl. No.: 17/074,645

(22) Filed: Oct. 20, 2020

(30) Foreign Application Priority Data
Mar. 27, 2020 (CN) 202010227447.8

(51) Int. Cl. G06Q 20/38; G06Q 10/04; G06Q 20/08; G06Q 20/02; G06F 16/901; G06N 3/12

(52) U.S. Cl. CPC G06Q 20/389; G06Q 10/047; G06N 3/126; G06Q 20/02; G06F 16/9024; G06Q 20/085

(57) ABSTRACT

A method for blockchain payment channel network multi-path routing based on a genetic algorithm includes: S1, constructing a directed graph according to a structure of a payment channel network; S2, based on the payment channel network, generating an initial population; S3, taking a total fee charge of the k payment paths corresponding to the each individual as an adaptability, and selecting a parent based on the adaptability; S4, based on the adaptability, performing a cross operation and a mutation operation on the parent; S5, when a population converges or a number of iterations reaches a preset threshold, determining the total fee charge for the each individual in a last-generation population, and selecting an individual with the smallest total fee charge as an optimal solution under a current k value; and, S6, selecting a target payment path from a plurality of selected payment paths.

### CROSS REFERENCE TO THE RELATED APPLICATIONS

This application is based upon and claims priority to Chinese Patent Application No. 202010227447.8, filed on Mar. 27, 2020, the entire contents of which are incorporated herein by reference.

### TECHNICAL FIELD

The present invention relates to the technical field of blockchain technology and computer network, and more particularly to a method for blockchain payment channel network multi-path routing based on a genetic algorithm.

### BACKGROUND

Blockchain, as one of the key technologies of distributed ledger, provides solution to credit related issue in open network without relying on third-party trusted institutions, Blockchain's characteristic of decentralization gives it a wide range of application prospects. However, blockchain protocol, such as Bitcoin, has inherent limitations in transaction throughput and transaction delay, for example, Bitcoin only supports about seven transactions per second, far from meeting market demands. Currently, off-chain payment channel network appears to be a solution in the mainstream for this problem, by limiting the use of blockchain to only establishing and/or closing payment channel, handling abnormal situations, a large number of small payments would not need to access the blockchain, thereby possibly lower transaction delays and increase transaction throughput limits.

One payment channel allows multiple payment transactions between two users without submitting each transaction to the blockchain. The payment channel deposits electronic funds into a multi-signature address that is controlled by both users and ensures that all electronic funds are returned within the time frame which is agreed upon by both parties when the channel is closed. When two users submit a channel establishment transaction on the chain to open a payment channel, both parties can make payment by adjusting the balance at both ends of the channel. When off-chain payment is no longer needed, (or when the capacity of the payment channel is exhausted), the payment channel closes and submits a closed transaction on the blockchain, the closed transaction then sends the stored electronic funds to each user according to the latest remaining balance information in the payment channel.

There are several issues with the method in prior art, the technical problems that the inventor identifies while implementing the present invention are as follow:

Given that a payment channel network is a network formed by multiple users and payment channels between them, to improve the usability and practicality of payment channels, an indirect path from a particular sender of payment to the corresponding receiver should be identified by the payment channel network without requiring a payment channel to be established between every two users who want to make off-chain payments. Although the routing of payment channel networks is similar to the routing of computer networks with certain routing restrictions, traditional computer network routing algorithms cannot support payment channel network routing because of certain particularity of the payment channel networks. There are relatively few researches on the routing algorithm of payment channel network, some existing algorithms only focus on finding a possible path without considering the improvement on payment success rate through multiple paths or the possibilities of forwarding fee reduction.

Thus, there is a technical problem of payment channel low success rate in the prior art.

### SUMMARY

To solve or at least partially solve the above technical problem of payment channel low success rate, the present invention provides a method for blockchain payment channel network multi-path routing based on a genetic algorithm. The method includes:

S1: constructing a directed graph G according to a structure of a payment channel network, wherein, within G, a vertex is used to represent a node participating in a transaction, an edge represents a payment channel, and the payment channel is used to forward the transaction; attributes of the payment channel include a balance, bal(u,v), a base fee charge coefficient, base(u,v), and a proportional fee charge coefficient, slope(u,v); a weight of the edge represents a fee charge Fee generated by a payment amount flowing through a current payment channel; Fee=base(u,v)+slope(u,v)×p, indicates the fee charge for forwarding the transaction, and p indicates the payment amount on a payment path; the payment path is a path from a sender to a receiver and is formed by points in graph G, and one payment path includes one or more payment channels;

S2: based on the payment channel network, generating an initial population, wherein, each individual within the initial population corresponds with k payment paths and the payment amount allocated on each of the k payment paths; the payment amount, represented as P₁, P₂, . . . Pₖ, is evenly distributed according to a total amount:

S3: taking a total fee charge of all payment paths corresponding to each individual as an adaptability, and selecting a parent based on the adaptability, wherein a fee charge of the payment path is a sum of fee charges of all of the payment channels included in the each payment path;

S4: based on the adaptability, performing a cross operation and a mutation operation on the parent;

S5: when a population converges or the number of iterations reaches a preset threshold, determining the total fee charge for each individual in a last-generation population, and selecting an individual with the smallest total fee charge as an optimal solution under a current k value, wherein the optimal solution under the currently k value is a plurality of selected payment paths; and

S6: selecting a target payment path from the plurality of payment paths.

In one embodiment according to the present invention, prior to step S2, the method further includes:

setting a path number range krange and an iteration threshold.

In one embodiment according to the present invention, step S2 includes:

S2.1: evenly distributing initial distribution amounts of the k paths of each individual, P₁=P₂= . . . =Pₖ=P/k, wherein P represents the total amount;

S2.2: determining k+1 least-fee-charged paths by using a Dijkstra algorithm, wherein the payment amount on each path is represented by P/k;

S2.3: generating one individual by selecting k payment paths from the k+1 payment paths obtained in step S2.2; and

S2.4: generating k+1 different individuals to form the initial population by repeating steps S2.2-2.3.

In one embodiment according to the present invention, step S3 specifically includes:

S3.1: determining the adaptability by using:

$$totalFee = {\sum }_{i = 1}^{k} {\sum }_{every channel in path } base ( u , v ) + slope ( u , v ) \times {P}_{i}$$

S3.2: selecting α*k individuals with the smallest totalFee as the parent based on a probability value α, and eliminating other individuals, where α is a preset parameter.

In one embodiment according to the present invention, step S4 specifically includes:

S4.1: randomly selecting two paths within each individual, performing the cross operation if the two paths have a common node in addition to a starting point and an ending point, and forming a new population by a parent individual and an individual obtained after the cross operation; and

S4.2: performing the mutation operation on each individual obtained by the cross operation based on a probability value β, where β is a preset parameter.

In one embodiment according to the present invention, the cross operation of step S4.1 specifically includes:

exchanging payment channels before and after the common node of the two paths, and, maintaining the number of individuals in the population formed after the cross operation to be consistent with the number of individuals in the initial population.

In one embodiment according to the present invention, the mutation operation of step S4.2 includes:

randomly adjusting the payment amount on each path within a preset range while the total amount remains unchanged; and

randomly selecting one node in the path to mutate into another random node.

In one embodiment according to the present invention, subsequent to step S4, the method further includes: determining whether a payment path in an individual obtained through the cross operation and the mutation operation meets a routing restriction condition, and revoking the cross operation and the mutation operation if the routing restriction condition is not met.

The above one or more technical solutions in the embodiments of this application have at least one or more of the following technical effects:

The present invention provides a method for blockchain payment channel network multi-path routing based on a genetic algorithm, which is directed at the characteristics of the blockchain off-chain payment channel network, the method utilizes the concept of genetic algorithm to generate diversified solutions through continuous iteration, and selects the best solution from the diversified solution to be modified into the solution for the next generation thereby approaches the optimal solution. Thus, the method according to the present invention obtains the local optimal multi-path routing solution, which greatly improves the success rate of payment through the payment channel and effectively reduces the costs incurred during the payment process.

### BRIEF DESCRIPTION OF THE DRAWINGS

In order to further illustrate the specific embodiments of the present invention or demonstrate the technical solutions in the prior art, the drawings that need to be used in the specific embodiments or the description in the prior art will be briefly introduced. It will be apparent to those skilled in the art that the drawings in the following description are some embodiments of the present invention and that other drawings can be obtained from these drawings without any creative effort.

FIG. 1 is a flow diagram of a method for blockchain payment channel network multi-path routing based on a genetic algorithm according to the present invention;

FIG. 2 is a schematic diagram of a payment channel network (PCN) structure according to the present invention; and

FIG. 3 shows a table that lists the attribute values of the PCN of FIG. 2.

### DETAILED DESCRIPTION OF THE EMBODIMENTS

To solve the problem of minimizing the forwarding costs in a blockchain off-chain payment channel network through multi-path routing, the present invention provides a method for blockchain payment channel network multi-path routing based on a genetic algorithm that achieves the purpose of improving the success rate of payment channels.

To meet the above objective, the main concept of the present invention is as follow:

A payment channel network is described as a special network with certain routing restrictions, the genetic algorithm is utilized to obtain the optimal payment path selection and payment amount distribution plan. The present invention discloses a method for blockchain off-chain payment channel network multi-path routing based on a genetic algorithm that generates diversified solutions through continuous iteration and selects the best solution to be modified into a solution for the next generation, thereby approaches the optimal solution. Thus, the method according to the present invention obtains a local optimal multi-path routing solution, which greatly improves the success rate of payment through the payment channel and effectively reduces the costs incurred during the payment process.

The technical solutions in the embodiments of the present invention will be described clearly and completely in combination with the drawings of the embodiments of the present invention. Obviously, the described embodiments here only encompass some of the embodiments according to the present invention, and that they are not exhaustive. Based on the embodiments of the present invention, all other embodiments obtained by ordinary skills in the art without creative labor will fall within the protection scope of the present invention.

Based on the genetic algorithm, the present invention considers the characteristics of a blockchain off-chain payment channel network and provides a multi-path routing method in payment channel network. The method according to the present invention fully considers the difference between the blockchain off-chain payment channel network and a traditional network, and takes an iterative approach to reach the optimal solution by continuous mutation and selection through the genetic algorithm. The present invention greatly improves the success rate of payment through the payment channel and effectively reduces the costs incurred during the payment process.

One embodiment according to the present invention provides a method for blockchain payment channel network multi-path routing based on a genetic algorithm, the method includes:

S1: a directed graph G is constructed according to the structure of a payment channel network. Specifically, within G, the vertex is used to represent the account that holds electronic funds, and the edge represents the payment channel, and the payment channel is used to forward a transaction. Attributes of the payment channel include a balance, bal(u,v), a base fee charge coefficient, base(u,v), and a proportional fee charge coefficient, slope(u,v). The weight of the edge represents the fee charge, Fee, which is generated by a payment amount that flows through the current payment channel, Fee=base(u,v)+slope(u,v)×p indicates the fee charge for forwarding the transaction, and p indicates the payment amount on the payment path. The payment path is the path from the sender to the corresponding receiver and is formed by the points in graph G, and one payment path includes one or more payment channels.

Specifically, the vertex set V represents the accounts that hold electronic funds, and the weighted edge set E represents the payment channels. The restriction condition for each payment channel on the payment path with the payment amount p is bal(u,v)≥p.

S2: based on the payment channel network, an initial population is generated. Each individual within the initial population corresponds with k payment paths and the payment amount allocated on each of the k payment paths. The payment amount, represented as P₁, P₂, . . . Pₖ, is evenly distributed according to the total amount.

S3: the total fee charge of all payment paths corresponding to each individual is taken as an adaptability, and a parent is selected based on the adaptability. The fee charge of the payment path is the sum of the fee charges of all of the payment channels included in the payment path.

S4: based on the adaptability, a cross operation and a mutation operation are performed on the parent.

S5: when the population converges or the number of iterations reaches a preset threshold, the total fee charge for each individual in the last-generation population is determined, and the individual with the smallest total free is selected as the optimal solution under the current k value, the optimal solution under the currently k value is a plurality of selected payment paths.

S6: the target payment path is selected from the plurality of payment paths.

Specifically, in step S3, the total fee charge of all payment paths is taken as the adaptability, the fee charge of each payment path is the sum of the fee charges of all of the payment channels included in each payment path, and the total fee charge of the individual can be obtained by integrating all of the payment paths corresponding to the individual.

In one embodiment according to the present invention, prior to step S2, the method further includes:

setting a path number range krange and an iteration threshold.

Specifically, iterative operations are performed for k from 2 to krange.

In one embodiment according to the present invention, step S2 includes: S2.1: the initial distribution amounts of the k paths of each individual are evenly distributed, P₁=P₂= . . . =Pₖ=P/k, and P represents the total amount;

S2.2: k+1 least-fee-charged paths are determined by using the Dijkstra algorithm, and the payment amount on each path is represented by P/k;

S2.3: one individual is generated by selecting k payment paths from the k+1 payment paths obtained in step S2.2; and

S2.4: k+1 different individuals are generated to form the initial population by repeating steps S2.2-2.3.

In one embodiment according to the present invention, step S3 specifically includes: S3.1: the adaptability is determined by using:

$$totalFee = {\sum }_{i = 1}^{k} {\sum }_{every channel in path } base ( u , v ) + slope ( u , v ) \times {P}_{i}$$

S3.2: the α*k individuals with the smallest totalFee are selected as the parent based on the probability value α, and other individuals are eliminated, where α is a preset parameter.

In one embodiment according to the present invention, step S4 specifically includes: S4.1: two paths within each individual are selected randomly, the cross operation is performed if the two paths have a common node in addition to the starting and ending points, and a new population is formed by the parent individual and the individual obtained after the cross operation; and

S4.2: the mutation operation is performed on each individual obtained by the cross operation based on the probability value p, where p is a preset parameter.

In one embodiment according to the present invention, the cross operation of step S4.1 specifically includes:

exchanging the payment channels before and after the common node of the two paths, and, maintaining the number of individuals in the population formed after the cross operation to be consistent with the number of individuals in the initial population.

Specifically, the cross operation is performed by exchanging the payment channels before and after the common node, for example, after the cross operation, path (1,2,4,5,6,8,10) and (1,3,5,7,9,10) becomes (1,2,4,5,7,9,10) and (1,3,5,6,8,10), respectively.

Additionally, the number of individuals in the population formed after the cross operation is maintained to be consistent with the number of individuals in the initial population. If the number of the individuals in the population formed after the cross operation is greater than the number of individuals in the initial population, the individual with the largest totalFee is eliminated. If the number of the individuals in the population formed after the cross operation is fewer than the number of individuals in the initial population, the parent individual is replicated as a new individual supplement.

In one embodiment according to the present invention, the mutation operation of step S4.2 includes:

randomly adjusting the payment amount on each path within a preset range while the total amount remains unchanged; and randomly selecting one node in the path to mutate into another random node.

In one embodiment according to the present invention, subsequent to step S4, the method further includes: determining whether the payment path in the individual obtained through the cross operation and the mutation operation meets the routing restriction condition, revoking the the cross operation and the mutation operation if the routing restriction condition is not met.

Specifically, the routing restriction of the payment path is conditioned upon whether the balance on the payment channel is greater than the payment amount, if the balance on the payment channel is less than the payment amount, then the operations are revoked.

If the population converges or the number of iterations reaches tmax, stop iteration, otherwise increase the value t, and return to the step of generating the initial population. If iteration stops, the totalFee of each individual in the last-generation population is determined, and the individual with the smallest totalFee is selected as the optimal solution under the current k value.

For each k value after performing steps 2-5, the individual with the smallest totalFee and its corresponding k value are output.

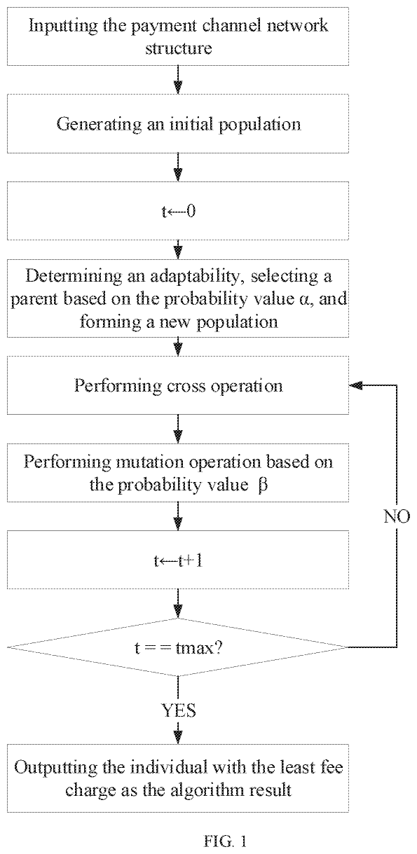

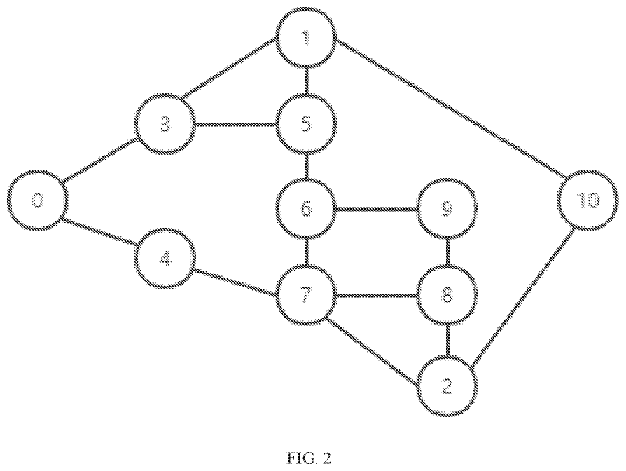

The flows of the method according to the present invention can be implemented by computer software. As shown in FIG. 1 and FIG. 2, the network structure diagram is taken as an example to illustrate the flows of the method according to the present invention as follow.

Step 1, the network topology of the payment channel network is input, the specific form is a directed graph G=(V,E). Each edge (payment channel) includes three attributes of the payment channel: balance, bal(u,v); base fee charge coefficient, base(u,v); and proportional fee charge coefficient, slope(u,v). The sender node s, the receiver node t, and the total payment amount P are input. The maximum number of loop iterations is set to be tmax, the genetic probability is set to be a, and the mutation probability is set to be β.

The implementation process of the embodiment is as follow:

The network topology of the payment channel network is input, the specific form is a directed graph G=(V,E), in graph G, the vertex set V represents the accounts that hold electronic funds, the weighted edge set E represents the payment channels. According to the present invention, each edge (payment channel) includes three attributes of the payment channel: balance, bal(u,v); base fee charge coefficient, base(u,v); and proportional fee charge coefficient, slope(u,v). The restriction condition for each payment channel on the payment path with the payment amount p is bal(u,v)≥p. The fee charge on the payment channel is Fee=base(u,v)+slope(u,v)×p, indicating the fee charge for forwarding transaction. For ease of explanation, according the present invention, the bidirectional path between u and v is denoted by two directed edges, one in each direction.

The sender node s, the receiver node t, and the total payment amount P are input. The maximum number of loop iterations is set to be tmax, the genetic probability is set to be α∈[0,1], and the mutation probability is set to be β∈[0,1].

Specific implementation of an example is as follow:

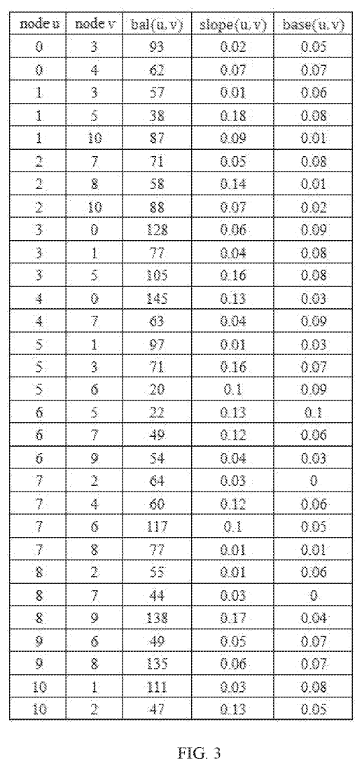

The network topology of the payment channel network is randomly set as shown in FIG. 2, each payment channel is bidirectional, and its balance bal(u,v), base fee charge coefficient base(u,v) and proportional fee charge coefficient slope(u,v) are shown in the table of FIG. 3. Set s=0, t=10, P=100, tmax=20, α=0.4, β=0.5.

Step 2, the path number range is set to be krange, the current number of iterations is set to be t=0, for k from 2 to krange, the following steps 3-7 are performed, respectively.

The implementation process of the embodiment is as follow:

The path number range is set to be krange ≥2, for k from 2 to krange, steps 3-7 are performed, respectively, to find solutions with different number of paths, and the solution with the least fee charge is selected to output as the optimal solution.

Specific implementation of an example is as follow:

Setting krange=3, for k=2 and k=3, steps 3-7 are performed, respectively, to determine the solution with the least fee charge.

Step 3, the initial population is generated. The initial population contains k+1 individuals. Each individual within the initial population corresponds with k payment paths and the payment amount allocated on each of the k payment paths. The payment amount is represented as P₁, P₂, . . . Pₖ. Implementation is as follow:

\textcircled{1} the initial distribution amounts of the k paths of each individual are evenly distributed, that is P₁=P₂= . . . =Pₖ=P/k;

\textcircled{2} k+1 different least-fee-charged paths are determined by using the Dijkstra algorithm, the payment amount on each path is represented by P/k;

\textcircled{3} one individual is generated by selecting k payment paths from the k+1 payment paths obtained in \textcircled{2}; and

\textcircled{4} a total of k+1 different individuals are generated to form the initial population.

The implementation process of the embodiment is as follow:

k+1 different least-fee-charged paths are determined by using the Dijkstra algorithm, and the initial distribution amount for each path is evenly allocated, all equal to amount P/k.

Specially, after each path is obtained by using the Dijkstra algorithm, the balance of the channel with the least balance in the path is set to 0, so that k+1 paths are not repeated. After the algorithm ends at this step, the balance of the channel returns to its original normal value. Finally, k paths are selected from the k+1 paths found to generate one individual. A total of k+1 different individuals can be generated to form the initial population.

Specific implementation of an example is as follow:

Steps 3-7 of this embodiment take k=2 as an example to illustrate the specific implementation of the present invention, when k=2,

\textcircled{1} P₁=P₂=P/k=100/2=50.

\textcircled{2} Use Dijkstra algorithm to determine 3 different least-fee-charged paths:

path1: (0, 3, 1, 10)

path2: (0, 4, 7, 8, 2, 10)

path3: (0, 4, 7, 2, 10)

\textcircled{3} Generate an initial population as:

Individual 1: {path1: (0, 4, 7, 8, 2, 10), path2: (0, 4, 7, 2, 10), P₁=P₂=50}

Individual 2: {path1: (0, 3, 1, 10), path2: (0, 4, 7, 2, 10), P₁=P₂=50}

Individual 3: {path1: (0, 3, 1, 10), path2: (0, 4, 7, 8, 2, 10), P₁=P₂=50}

Step 4, an adaptability is determined and a parent is selected. For each individual, the total fee charges of all payment paths of each individual is determined as the adaptability. The total fee charges of all of k paths of each individual are determined, and the sum is determined by using: totalFee=Σᵢ₌₁^{k}Σ_{every channel in path} base(u,v)+slope(u,v)×Pᵢ. The α*k individuals with the smallest totalFee are selected as the parent based on the probability value α, and other individuals are eliminated.

The implementation process of the embodiment is as follow:

For each individual, the total fee charges of its k paths are determined, and the sum is determined by using: totalFee=Σᵢ₌₁^{k}Σ_{every channel in path} base(u,v)+slope(u,v)×Pᵢ. The α*k individuals with the smallest totalFee are selected as the parent based on the probability value α, and other individuals are eliminated.

Specific implementation of an example is as follow:

the total fee charges of k paths of each individual are determined:

Individual 1: totalFee=[base(0,4)+slope(0,4)×50+base(4,7)+slope(4,7)×50+base(7,8)+slope(7,8)×50+base(8,2)+slope(8,2)×50+base(2,10)+slope(2,10)×50]+[base(0,4)+slope(0,4)×50+base(4,7)+slope(4,7)×50+base(7,2)+slope(7,2)×50+base(2,10)+slope(2,10)×50]=10. 25+10.68=20.93

Also available:

Individual 2: totalFee=7.64+10.68=18.32

Individual 3: totalFee=7.64+10.25=17.89

α=0.4, so one individual is selected as the parent. The individual with the least totalFee is Individual 3, so Individual 3 is selected as the parent, and Individual 1 and Individual 2 are eliminated.

Parent 1: {path1: (0, 3, 1, 10), path2: (0, 4, 7, 8, 2, 10), P₁=P₂=50}

Step 5, cross operation is performed. Two paths within each individual are selected randomly, the cross operation is performed if the two paths have a common node in addition to the starting and ending points, and a new population is formed by the parent individual and the individual obtained after the cross operation. Specifically, the cross operation is performed by exchanging the paths before and after the common node, for example, after the cross operation, path (1,2,4,5,6,8,10) and (1,3,5,7,9,10) becomes (1,2,4,5,7,9,10) and (1,3,5,6,8,10), respectively.

The implementation process of the embodiment is as follow:

Cross Operation. Two paths within each individual are selected randomly, the cross operation is performed if the two paths have a common node in addition to the starting and ending points, and a new population is formed by the parent individual and the individual obtained after the cross operation. Specifically, the cross operation is performed by exchanging the paths before and after the common node, for example, after the cross operation, path (1,2,4,5,6,8,10) and (1,3,5,7,9,10) becomes (1,2,4,5,7,9,10) and (1,3,5,6,8,10), respectively. Additionally, the number of individuals in the population formed after the cross operation is maintained to be consistent with the number of individuals in the initial population. If the number of the individuals in the population formed after the cross operation is greater than the number of individuals in the initial population, the individual with the largest totalFee is eliminated. If the number of the individuals in the population formed after the cross operation is fewer than the number of individuals in the initial population, the parent individual is replicated as a new individual supplement.

Specific implementation of an example is as follow:

The parent obtained in Step 4 is as follow:

Parent 1: (path1: (0, 3, 1, 10), path2: (0, 4, 7, 8, 2, 10), P₁=P₂=50)

The two paths in the parent do not have a common node other than the starting point and the end point, therefore, the cross operation is not performed, and the parent individual is replicated as the new individual to form a new population.

The new population obtained after the cross operation is as follow:

Individual 1: (path1: (0, 3, 1, 10), path2: (0, 4, 7, 8, 2, 10), P₁=P₂=50)

Individual 2: {path1: (0, 3, 1, 10), path2: (0, 4, 7, 8, 2, 10), P₁=P₂=50}

Individual 3: {path1: (0, 3, 1, 10), path2: (0, 4, 7, 8, 2, 10), P₁=P₂=50}

Note, for the simplicity and intuitiveness of this description, the present embodiment selects the case of k=2, which is convenient for calculation, and uses a small network with only 11 nodes. When the number of network nodes is larger and the value of k is larger, there will be α*k parent individuals obtained in Step 4, and the k paths in each individual will have a greater probability of having a common node. At that time, the cross operation will proceed. However, if any path generated after the cross operation violates the routing restriction condition in the payment channel network, namely, the balance on the payment channel is greater than the payment amount, the cross operation will be revoked.

Step 6, the mutation operation is performed. The mutation operation is performed on each individual based on the probability value β. The mutation operation is divided into two steps: 1 randomly adjusting the payment amount on each path within the preset range while the total amount remains unchanged, \textcircled{2} randomly selecting one node in the path to mutate into another random node.

The implementation process of the embodiment is as follow:

Mutation Operation. The mutation operation is performed on each individual based on the probability value β. The mutation operation is divided into two steps: \textcircled{1} randomly adjusting the payment amount on each path within a preset range while the total amount remains unchanged, \textcircled{2} randomly selecting one node in the path to mutate into another random node. If any path generated after an operation violates the routing restriction condition in the payment channel network, namely, the balance on the payment channel is greater than the payment amount, the mutation operation will be revoked.

Specific implementation of an example is as follow:

Population obtained in Step 5 is as follow:

Individual 1: {path1: (0, 3, 1, 10), path2: (0, 4, 7, 8, 2, 10), P₁=P₂=50}

Individual 2: {path1: (0, 3, 1, 10), path2: (0, 4, 7, 8, 2, 10), P₁=P₂=50)

Individual 3: {path1: (0, 3, 1, 10), path2: (0, 4, 7, 8, 2, 10), P₁=P₂=50}

Mutation operation is performed based on the probability value of R=0.5, and the mutated population is as follow:

Individual 1: {path1: (0, 3, 1, 10), path2: (0, 4, 7, 8, 2, 10), P₁=50, P₂=50}

Individual 2: {path1: (0, 3, 1, 10), path2: (0, 4, 7, 8, 2, 10), P₁=53, P₂=47}

Individual 3: {path1: (0, 3, 1, 10), path2: (0, 4, 7, 8, 2, 10), P₁=48, P₂=52}

Step 7, if the number of iterations reaches tmax, stop iteration, otherwise increase the value t, and return to the Step 3. If iteration stops, the totalFee of each individual in the last-generation population is determined and the individual with the smallest totalFee is selected as the optimal solution under the current k value.

The implementation process of the embodiment is as follow:

If the number of iterations reaches tmax, stop iteration, otherwise increase the value t, and return to the Step 3. The value for tmax is adjustable according to different network structures to enable the algorithm to obtain an optimal result. At the end of the iteration, the totalFee of each individual in the last-generation population is determined and the individual with the smallest totalFee is selected as the optimal solution under the current k value.

Specific implementation of an example is as follow:

In this example, t=0, increase t to t=1, return to Step 3.

Since the network structure of the present embodiment is relatively simple, the value for tmax is set to be tmax=20. After repeating iteration according to Steps 3-6 for 20 times, the last-generation population obtained is as follow:

Individual 1: {path1: (0, 3, 1, 10), path2: (0, 4, 7, 8, 2, 10), P₁=66, P₂=34}

Individual 2: {path1: (0, 3, 1, 10), path2: (0, 4, 7, 8, 2, 10), P₁=71, P₂=29}

Individual 3: {path1: (0, 3, 1, 10), path2: (0, 4, 7, 8, 2, 10), P₁=70, P₂=30}

The totalFee of each individual is determined as follow:

Individual 1: totalFee=17.09

Individual 2: totalFee=16.84

Individual 3: totalFee=16.9 Thus, Individual 2 is selected as the optimal solution when k=2, namely {path1: (0, 3, 1, 10), path2: (0, 4, 7, 8, 2, 10), P₁=71, P₂=29}.

Step 8, for each k value after performing Steps 3-7, the individual with the smallest totalFee and its corresponding k value are output.

The implementation process of the embodiment is as follow:

For each value of k from 2 to krange, the individual with the smallest totalFee is selected as the output of the algorithm after performing Steps 3-7.

Specific implementation of an example is as follow:

The steps for when k=3 and k=2 are the same, and the final results are as follow:

{path1: (0, 3, 1, 10), path2: (0, 4, 7, 8, 2, 10), path3: (0, 4, 7, 2, 10), P₁=60, P₂=30, P₂=10), totalFee=17.67.

Therefore, the final output result according to the method of the present invention is the solution when k value is k=2, thus {path1: (0, 3, 1, 10), path2: (0, 4, 7, 8, 2, 10), P₁=71, P₂=29}.

It will be apparent to those skilled in the art that the present invention is not limited to the details of the exemplary embodiments described above and that the present invention can be embodied in other specific forms without departing from the spirit or essential characteristics thereof. The embodiments are therefore to be considered in all respects as illustrative and not restrictive, the scope of the present invention being defined by the appended claims rather than by the foregoing description, and all changes coming within the meaning and range of equivalency of the claims are therefore intended to be embraced therein. Any reference numerals in the claims shall not be construed as limiting the claim concerned.

Furthermore, it should be understood that although the specification is described in accordance with the embodiments, not each embodiment contains only one independent technical solution. This description of the specification is only for clarity. Those skilled in the art should take the specification as a whole, and the technical solutions in each embodiment can be appropriately combined to form other embodiments as would be understood by those skilled in the art.

What is claimed is:

1. A method for blockchain payment channel network multi-path routing based on a genetic algorithm, comprising:
S1: constructing a directed graph according to a structure of a payment channel network, wherein, within the directed graph, a vertex is configured to represent a node participating in a transaction, an edge represents a payment channel, and the payment channel is configured to forward the transaction; wherein, attributes of the payment channel comprise a balance, bal(u,v), a base fee charge coefficient, base(u,v), and a proportional fee charge coefficient, slope(u,v); wherein, a weight of the edge represents a fee charge Fee generated by a payment amount flowing through a current payment channel; wherein, Fee=base(u,v)+slope(u,v)×p, indicates the fee charge for forwarding the transaction, and p indicates the payment amount on a payment path; wherein, the payment path is a path from a sender to a receiver and is formed by points in the directed graph, and one payment path comprises one or more payment channels;
S2: based on the payment channel network, generating an initial population, wherein, each individual within the initial population corresponds with k payment paths and the payment amount allocated on each payment path of the k payment paths; wherein, the payment amount is evenly distributed according to a total amount and represented as P₁, P₂, . . . Pₖ;
S3: taking a total fee charge of the k payment paths corresponding to the each individual as an adaptability, and selecting a parent based on the adaptability, wherein a fee charge of the each payment path is a sum of fee charges of all of the one or more payment channels comprised in the each payment path;
S4: based on the adaptability, performing a cross operation and a mutation operation on the parent;
S5: when a population converges or a number of iterations reaches a preset threshold, determining the total fee charge for the each individual in a last-generation population, and selecting an individual with a minimum total fee charge as an optimal solution under a current k value, wherein the optimal solution under the currently k value is a plurality of selected payment paths; and
S6: selecting a target payment path from the plurality of selected payment paths.

2. The method of claim 1, wherein, prior to step S2, the method further comprises:
setting a path number range krange and an iteration threshold.

3. The method of claim 1, wherein, step S2 comprises:
S2.1: evenly distributing initial distribution amounts of the k payment paths of the each individual, P₁=P₂= . . . =Pₖ=P/k, wherein P represents the total amount;
S2.2: determining k+1 least-fee-charged payment paths by using a Dijkstra algorithm, wherein the payment amount on the each payment path is represented by P/k;
S2.3: generating one individual by selecting k payment paths from the k+1 least-fee-charged payment paths obtained in step S2.2; and
S2.4: generating k+1 different individuals to form the initial population by repeating steps S2.2-2.3.

4. The method of claim 3, wherein, step S3 specifically comprises:
S3.1: determining the adaptability by using:
$$totalFee = {\sum }_{i = 1}^{k} {\sum }_{every channel in path } base ( u , v ) + slope ( u , v ) \times {P}_{i}$$
S3.2: selecting α*k individuals with the minimum total fee charge as the parent based on a probability value α, and eliminating other individuals, where α is a preset parameter.

5. The method of claim 1, wherein, step S4 specifically comprises:
S4.1: randomly selecting two payment paths within the each individual, performing the cross operation when the two payment paths have a common node in addition to a starting point and an ending point, and forming a new population by a parent individual and an individual obtained after the cross operation; and
S4.2: performing the mutation operation on each individual obtained by the cross operation based on a probability value β, where β is a preset parameter.

6. The method of claim 5, wherein, the cross operation of step S4.1 specifically comprises:
exchanging a payment channel before the common node and a payment channel after the common node of the two payment paths, and, maintaining a number of individuals in the new population formed after the cross operation to be consistent with a number of individuals in the initial population.

7. The method of claim 6, wherein, the mutation operation of step S4.2 comprises:
randomly adjusting the payment amount on the each payment path within a preset range while the total amount remains unchanged; and
randomly selecting one node in the payment path to mutate into another random node.

8. The method of claim 1, wherein, subsequent to step S4, the method further comprises:
determining whether a payment path in an individual obtained through the cross operation and the mutation operation meets a routing restriction condition, and revoking the cross operation and the mutation operation when the routing restriction condition is not met.
